(19) United States
(12) Patent Application Publication
(10) Pub. No.: US 2004/0136335 A1
(43) Pub. Date: Jul. 15, 2004

(54) Structure of circuit boards for wireless communication apparatus

(75) Inventors: Eric Oh-Yang, Hsinchu Hsien (TW); Hsu Jen Jung, Kaohsiung (TW)

Correspondence Address: CONNOLLY BOVE LODGE & HUTZ LLP, SUITE 800, 1990 M STREET NW, WASHINGTON, DC, 20036-3425, US

(73) Assignee: Abocom Systems Inc.

(21) Appl. No.: 10/411,213

(22) Filed: Apr. 11, 2003

(30) Foreign Application Priority Data
Jan. 15, 2003 (TW) 092200746

(51) Int. Cl. H04Q 7/00

(52) U.S. Cl. 370/328; 370/402

(57) ABSTRACT

The present invention reveals a structure of circuit boards for a wireless communication apparatus to increase product yield and throughput. The structure of circuit boards includes an RF module and a second circuit board, the RF module including a first circuit board and at least one RF device equipped on the first circuit board, the area of the second circuit board being no smaller than that of the first circuit board, and the first circuit board being disposed on the surface of the second circuit board.

### BACKGROUND OF THE INVENTION

1. Field of the Invention

The present invention is related to a structure of circuit boards, more specifically, to a structure including a plurality of circuit boards for a wireless communication apparatus.

2. Description of Related Art

With the development of wireless communication, cellular phones are becoming necessities for current communication, and WLANs (Wireless Local Area Network) are gradually replacing traditional cable networks. Nowadays, several companies utilize wireless manner to transfer digital data instead of a cable network of complex wiring. Additionally, many public areas such as international airports, hotels and coffee shops are also constructing WLANs to provide communication services to customers. Users can utilize a personal computer or a PDA (Personal Digital Assistant) equipped with a wireless network card to link to the nearest access point. Therefore, the accesses and operations of e-mails, web browses and network games can be achieved without time lag and distance.

Gateways and routers in addition to access points are common wireless communication apparatuses in a WLAN. Most of the circuit boards of the wireless communication apparatuses use SMT (Surface Mounting Technology) to adhere circuit devices such as base band, media access control (MAC) and radio-frequency (RF) devices onto the circuit boards. Accordingly, RF devices transfer high frequency signals, and thus the circuit design and the compatibility of related peripheral components are extremely important. Therefore, how to ensure that the RF device can exactly and stably operate is critical for wireless communication.

In order to achieve superior communication quality and stability, the new wireless communication protocol U-NII of 802.11a (47CFR15.401) additionally provides a band around 5 GHz for use. Furthermore, 802.11b/g ISM (47CFR15.247) designates that the band of 2.400-2.4835 GHz is used for radiation power below 1000 mW.

Accordingly, the bands under various communication protocols employ different RF devices. When different RF devices are equipped to a circuit board, it is hard to guarantee that the RF devices and the related electronic devices, e.g., resistors and capacitors, on a circuit board will cooperate as expected. If the set of an RF device and the related electronic devices cannot achieve expected performance, the whole circuit board may have to be discarded, which significantly increases the manufacturing cost. Therefore, how to reduce the cost of mismatched circuit board replacement due to different RF devices is presently essential.

### SUMMARY OF THE INVENTION

The objective of the present invention is to provide a structure of circuit boards for a wireless communication apparatus as an alternative to the traditional circuit board for yield improvement and production cost reduction.

The structure of circuit boards of the present invention includes an RF module and a second circuit board. The RF module is used for signal transmitting and receiving, and includes a first circuit board and at least one RF device equipped on the first circuit board. The area of the second circuit board is no smaller than that of the first circuit board, and the first circuit board is disposed on the surface of the second circuit board. The second circuit board is used to support the radio-frequency module and the design of the second circuit board is irrelevant to the type of the radio-frequency device so as to prevent the second circuit board from being affected by replacement of the radio-frequency device.

The feature of the present invention is to divide an original circuit board including all circuit devices into a larger circuit board and a smaller circuit board. First of all, an RF device with the related electronic elements are embedded into the smaller circuit board as an RF module, and a quality testing is performed on the RF module before being installed to the larger circuit board. If the RF module does not work properly, the smaller circuit board can be replaced before installation. Additionally, it is not necessary to consider the type of the RF device as to the larger circuit board.

Furthermore, two circuit boards of same size also can achieve substantially equivalent performance by forming the RF module in advance. Whereby the radio-frequency module is tested alone before being installed on the second circuit board, unqualified radio-frequency devices can be filtered out and will not affect the assembly process.

### BRIEF DESCRIPTION OF THE DRAWINGS

FIG. 1 illustrates the explosive view of the structure of circuit boards for a wireless apparatus in accordance with the present invention; and

FIG. 2 illustrates the structure of circuit boards for a wireless apparatus in accordance with the present invention.

### DETAILED DESCRIPTION OF THE INVENTION

RF signals are important for wireless communications, of which the quality is relative to the efficiency and quality of the wireless communication. An RF device is exemplified as follows to illustrate the present invention.

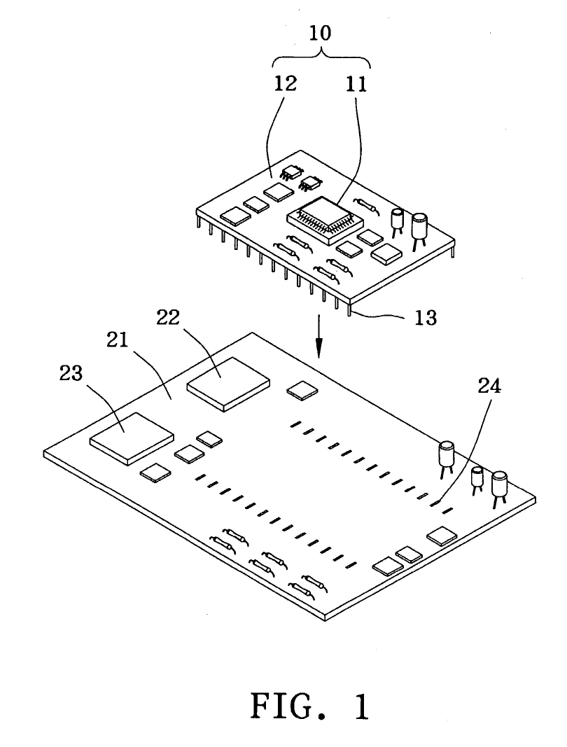

As shown in FIG. 1, an RF device 11 is equipped on the surface of a first circuit board 12 as an RF module 10. The first circuit board 12 may be provided with various electronic devices such as transistors, resistors, capacitors and inductors to cooperate with the RF device 11 to transmit and receive RF signals.

The quality and the stability of the RF module 10 are, as usual, hard to be controlled. Therefore, it is better to test the RF module 10 first to ensure that the intensity and the radiation pattern of the electromagnetic wave are acceptable.

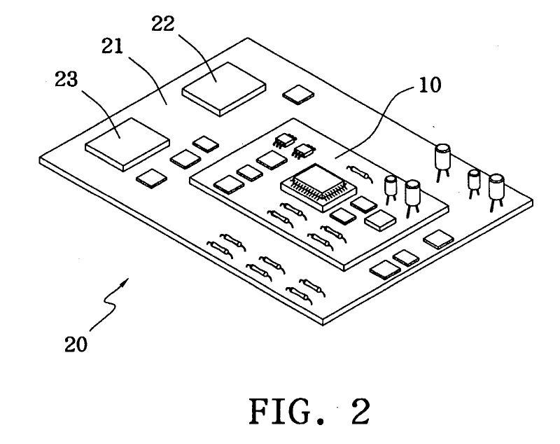

If the RF module 10 is qualified, the pins 13 of the first circuit board 12 are soldered with the pads 24 on a second circuit board 21 to form a structure of circuit boards 20 for a wireless communication apparatus as shown in FIG. 2. In other words, the structure of circuit boards 20 includes the first circuit board 12 and the second circuit board 21, where the first circuit board 12 is provided with the RF device 11, and the second circuit board 21 includes a base band device 22 and a MAC device 23 usually used for wireless communication. In addition, the area of the second circuit board 21 is larger than that of the first circuit board 12.

The structure of circuit boards 20 can prevent the abandonment of the unqualified circuit board; in addition, the RF device 11 can be made in accordance with various communication protocol such as 802.11a, 802.11b, 802.11d, 802.11e, 802.11f, 802.11g, 802.11i and Bluetooth. As a result, the second circuit board 21 can be standardized to combine various types of the RF module 10. Therefore, it meets the requirement of mass production. In addition, the RF device 11, which usually has defects, can be individually qualified, so the throughput and the yield of the structure of circuit boards 20 can be significantly improved.

Besides being connected by soldering, the RF module 10 and the second circuit board 21 can be connected by a connecting finger, a socket or a stamp as well to facilitate the RF module 10 replacement. Nevertheless, the cost may be increased, so all related factors have to be considered together to determine the manner of combination.

In accordance with the feature of the present invention, a structure including at least three circuit boards can be made as well. For instance, two smaller circuit boards are formed as two individual modules of different functions, and then the two modules are equipped on a larger circuit board, or a stacked structure are formed by three circuit boards. Furthermore, a device having functions other than that of the RF device 11 can be equipped on the first circuit board 12, as long as a manner is related to forming a module first to increase the yield and throughput of products and thus to reduce the cost, which should be contained in the scope of the present invention.

Besides being used in a current communication product such as a router, an access point, a gateway and a cellular phone, the structure of circuit boards 20 can be used in an information application (IA) apparatus such as a wireless refrigerator, an oven or a security system to facilitate everyday life.

The above-described embodiment of the present invention are intended to be illustratively only. Numerous alternative embodiments may be devised by those skilled in the art without departing from the scope of the following claims.

What is claimed is

1. A structure of circuit boards for a wireless communication apparatus, comprising:
a radio-frequency module, including:
a first circuit board provided with circuit devices for transmitting and receiving radio-frequency signals; and
at least one radio-frequency device equipped on the first circuit board; and
a second circuit board for supporting the radio-frequency module, wherein the area of the second circuit board is no smaller than that of the first circuit board, and the design of the second circuit board is irrelevant to the type of the radio-frequency device so as to prevent the second circuit board from being affected by replacement of the radio-frequency device;
whereby the radio-frequency module is tested alone before being installed on the second circuit board, and unqualified radio-frequency devices can be filtered out and will not affect an assembly process.

2. The structure of circuit boards in accordance with claim 1, wherein the circuit devices are selected from the group consisting of transistors, resistors, capacitors and inductors.

3. The structure of circuit boards in accordance with claim 1, wherein the second circuit board further includes a base band device.

4. The structure of circuit boards in accordance with claim 1, wherein the second circuit board further includes a media access control device.

5. The structure of circuit boards in accordance with claim 1, wherein the first circuit board and the second circuit board are connected by soldering.

6. The structure of circuit boards in accordance with claim 1, wherein the second circuit board includes a socket for receiving the first circuit board.

7. The structure of circuit boards in accordance with claim 1, wherein the second circuit board includes a connecting finger for connecting the first circuit board.

8. The structure of circuit boards in accordance with claim 1, which is used in an access point, a gateway or a router.

9. The structure of circuit boards in accordance with claim 1, wherein the radio-frequency module is in compliance with one of the protocols of 802.11a, 802.11b, 802.11c, 802.11d, 802.11e, 802.11f, 802.11g, 802.11i and Bluetooth.
